(19) United States
(12) Patent Application Publication
(10) Pub. No.: US 2018/0363216 A1
(43) Pub. Date: Dec. 20, 2018

(54) WALL MOUNTED WASHING MACHINE AND WATER SUPPLY VALVE ASSEMBLY

(71) Applicant: DONGBU DAEWOO ELECTRONICS CORPORATION, Seoul (KR)

(72) Inventor: Jong Jin LEE, Incheon (KR)

(21) Appl. No.: 15/884,185

(22) Filed: Jan. 30, 2018

(30) Foreign Application Priority Data
Jun. 14, 2017 (KR) 10-2017-0074629

(51) Int. Cl. D06F 39/02; F16K 11/24; F16K 31/04; D06F 39/08; D06F 37/20; D06F 37/26

(52) U.S. Cl. CPC D06F 39/028; F16K 11/24; F16K 31/046; D06F 39/04; D06F 37/20; D06F 37/267; D06F 39/088

(57) ABSTRACT

A wall mounted washing machine and a water supply valve assembly thereof are provided to reduce cost in the assembly process. The wall mounted washing machine includes a rear panel mounted on a wall; a tub supported on the rear panel, the tub being filled with wash water; a front panel having an opening formed therein and installed in the tub; a drum rotatably installed in the tub; a cover installed on the front panel to cover the front panel; a door rotatably coupled to the cover to open or close a laundry inlet of the cover; a cabinet coupled between the rear panel and the cover; and a water supply valve assembly installed on the front panel with respect to an inner lower space of the cabinet.

### RELATED CASE

This patent application claims benefit to Korean Patent Application No. 10-2017-0074629 filed Jun. 14, 2017, with inventor Jong Jin Lee, and whose specification is incorporated by reference herein.

### TECHNICAL FIELD

The present disclosure relates to a wall mounted washing machine and a water supply valve assembly thereof.

### BACKGROUND

A washing machine is an apparatus for separating contaminants from washed fabric (laundry) using wash water and detergent, wherein the contaminants may be separated from the washed fabric by the chemical action of the detergent dissolved in the wash water and the mechanical action (agitation) of the wash water and an inner basket. Such washing machines may be categorized into various types, including, a top loading type washing machine, a front loading type washing machine, and a combined type washing machine combined with the top loading type and the front loading type, depending on the method of laundry loading.

In recent years, wall mounted washing machines have been introduced, which may be installed in narrow spaces such as bathrooms and toilets. In general, the wall mounted washing machines employ the front loading type for miniaturization.

For example, the wall mounted washing machine may include a cabinet that forms an exterior of the device, a tub provided in the cabinet and operable to be filled with wash water, a drum rotatably installed in the tub and accommodating the laundry, a drive unit providing power to the drum for agitation, a water supply unit for supplying the wash water to the tub, and a drain unit for discharging the wash water from the tub to the outside of the cabinet.

In the prior art, a typical wall-mounted washing machine has a plurality of pipe lines or electromagnetic valves installed for the respective pipe lines for supplying detergent or conditioner to the inside of the tub at predetermined timings of the wash cycle.

For example, the wall-mounted washing machine of the prior art is further provided with pipe lines for supplying a detergent liquid made by mixing detergent into water that flows inside of the tub, and pipe lines for supplying a conditioner liquid made by mixing conditioner with water that flows to the inside of the tub.

However, the wall-mounted washing machine of the prior art has a disadvantage in that the plurality of pipe lines are installed separately, and therefore, the number of potential leakage points is relatively large.

In addition, in the washing machine of the prior art, because the inner volume of the casing is very narrow as compared with that of the washing machine of the top loading type, installing the additional components constituting the pipe lines can become very difficult such as arranging and fitting the tubes.

In addition, in the wall-mounted washing machine of the prior art, since an end of the water supply hose corresponding to a pipe line is directly coupled to the hole of the installation structure, the insertion depth to the end of the water supply hose is not constant, thereby causing the coupling between the end of the water supply hose and the hole of the installation structure to become loose, which may lead to product failures.

### SUMMARY

In order to solve the above disadvantages, embodiments of the present disclosure provides a wall mounted washing machine and a water supply valve assembly thereof, wherein a plurality of water supply pipes and control valves may be readily installed, and the water supply pipes may be expanded and installed according to additional functions of the washing machine, thereby greatly increasing the quality of the washing machine, reducing the manufacturing costs thereof and providing a lower cost assembly process. More specifically, embodiments of the present invention include a wall mounted washing machine, comprising: a rear panel operable to be mounted on a vertical surface; a tub supported on the rear panel, the tub operable to contain wash water; a front panel having an opening formed therein and disposed in the tub; a drum installed in the tub and operable to rotate; a cover installed on the front panel to protect a front surface of the front panel; a door rotatably coupled to the cover to open and close a laundry inlet of the cover; a cabinet coupled between the rear panel and the cover; and a water supply valve assembly provided in an inner lower space of the cabinet and installed on the front panel. Embodiments include the above and wherein the front panel comprises an extension integrally formed on a lower side of the front panel and operable to install the water supply valve assembly.

Embodiments include the above and wherein the extension comprises: a base plate extending from a side surface of the front panel; a base wall extending along an outer periphery of the base plate; a plate reinforcing rib connected to the base wall and protruding from the base plate; and a plurality of supports protruding from the extension with respect to the base plate, the base wall and the plate reinforcement rib, and wherein each of the plurality of supports has a bolt hole formed at its end.

Embodiments include the above and wherein each of the plurality of supports is spaced apart from the base plate or the plate reinforcement rib so that the water supply valve assembly may be disposed along an oblique direction from the extension with respect to the front surface of the front panel. Embodiments include the above and wherein the water supply valve assembly comprises supporting legs respectively fastened to the bolt holes of the plurality of supports.

Embodiments include the above and wherein the bolt holes of the supports are formed at the end of the plurality of supports toward the water supply valve assembly. Embodiments include the above and wherein the plurality of supports has a protruding height that allows the water supply valve assembly to be spaced from the base plate or the plate reinforcing rib. Embodiments include the above and wherein the plurality of supports comprises: a support base integrally formed with the base plate or the plate reinforcing rib; and a support extension having a relatively small diameter as compared with the support base and thus a step difference and projecting from the support base toward the water supply valve assembly.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view showing the appearance of a wall mounted washing machine according to an embodiment of the present disclosure;

FIG. 2 is a view showing a state in which the door of FIG. 1 is opened.

FIG. 3 is a rear perspective view of the washing machine of FIG. 1;

FIG. 4 is an exploded perspective view of the washing machine of FIG. 1;

FIG. 5 is a front view of the front panel of FIG. 4;

FIG. 6 is an exploded perspective view of the front panel shown in FIG. 5;

FIG. 7 is a front view enlarging a state in which a water supply valve assembly in accordance with embodiments of the present invention is installed on the front panel of FIG. 6;

FIG. 8 is a rear perspective view of the water supply valve assembly shown in FIG. 7;

FIG. 9 is a front view of the valve body of the water supply valve assembly of FIG. 8;

FIG. 10 is a rear view of the valve body of FIG. 9;

FIG. 11 is an exploded perspective view of the water supply valve assembly shown in FIG. 6;

FIG. 12 is a perspective view of the single bracket shown in FIG. 11;

FIG. 13 is a front view in which a first control valve is coupled to the single bracket shown in FIG. 12;

FIG. 14 is a rear perspective view for describing valve operations of a water supply valve assembly; and

FIG. 15 is a perspective view for describing the inside of a washing machine having a drying unit according to an exemplary application of the present disclosure.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they would unnecessarily obscure the features of the subject matter of the present disclosure.

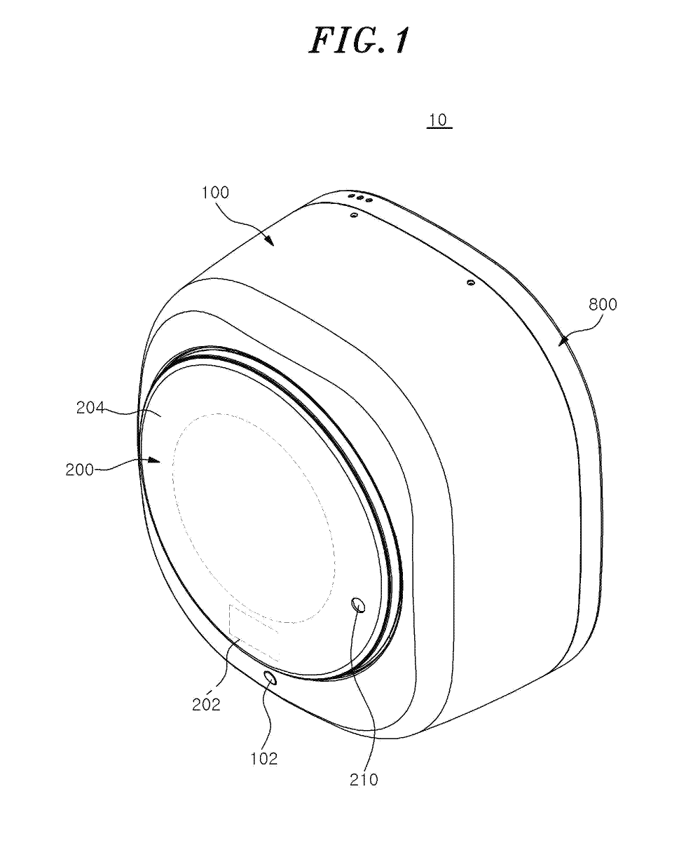

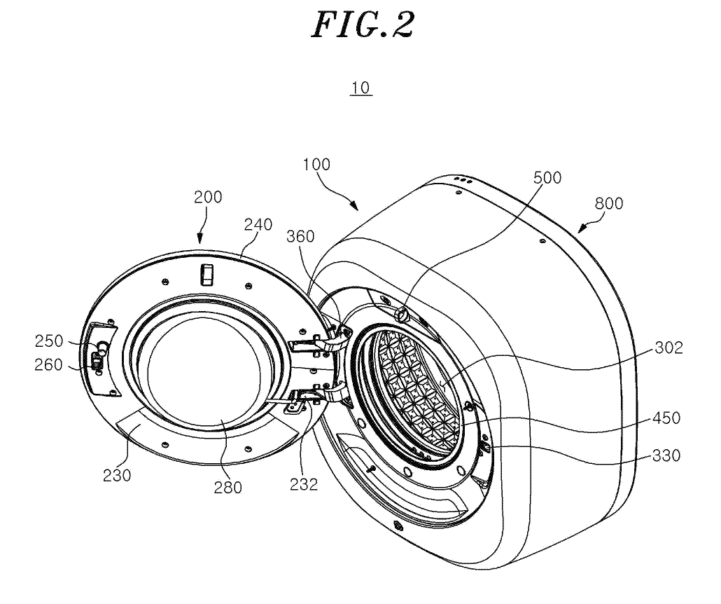

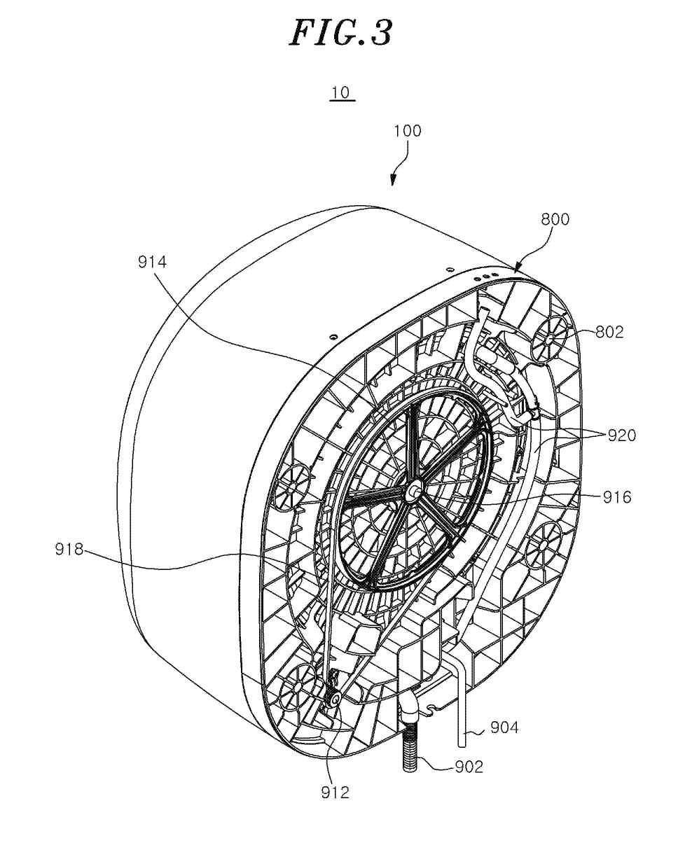

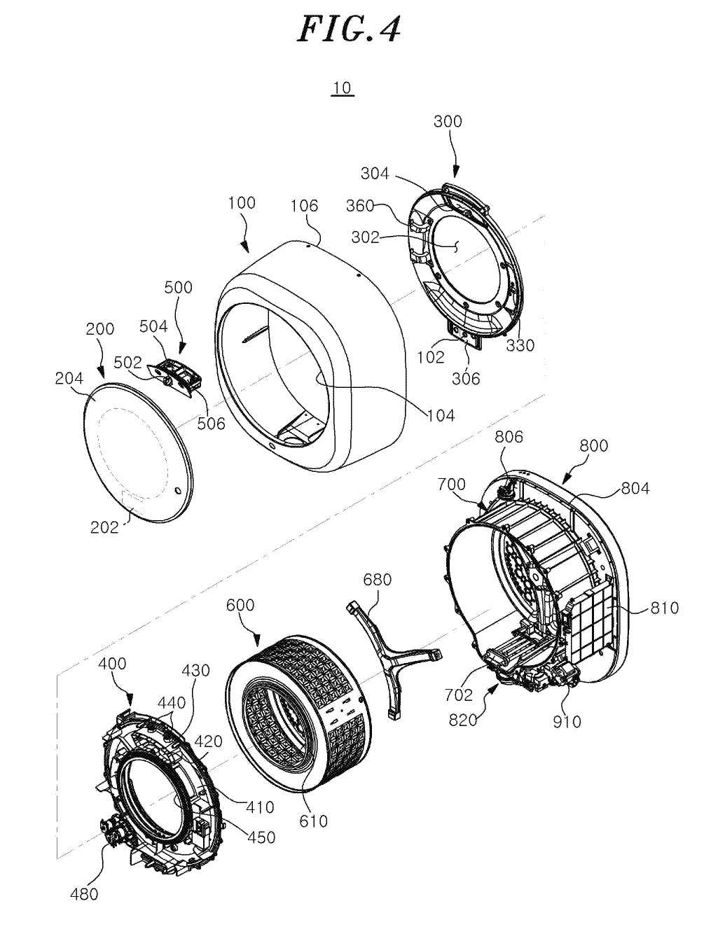

FIG. 1 is a perspective view showing the appearance of a wall mounted washing machine according to an embodiment of the present disclosure, FIG. 2 is a view showing a state in which the door of FIG. 1 is opened, FIG. 3 is a rear perspective view of the washing machine of FIG. 1, and FIG. 4 is an exploded perspective view of the washing machine of FIG. 1.

Referring to FIGS. 1 to 4, a wall-mounted washing machine 10 according to an embodiment of the present disclosure may include a cabinet 100 having a front surface and a rear surface opened and forming an outer appearance, a door 200 disposed on one side of the cabinet 100 and for opening or closing the opened front surface of the cabinet 100, a cover 300 connected to the door 200 for opening and closing the door 200, a front panel 400 disposed on the rear surface of the cover 300, a detergent container 500 housed in one side of the front panel 400 and accommodating detergent and conditioner, a drum 600 in which laundry is stored, a tub 700 which surrounds the drum 600 and is filled with wash water, and a rear panel 800 mounted on the wall. Here, the rear surface means a surface close to the wall, and the front surface means a surface opposite to the rear surface.

Specifically, the cabinet 100 may be provided in an empty form. Also, the cabinet 100 may include a power button 102 for controlling a power supply, a cover connection unit 104 connected to the cover 300, and a rear panel connection unit 106 connected to the rear panel 800.

The power button 102 may be provided on one side of the cabinet 100 to control whether the washing machine 10 is turned on or off. The power button 102 may be provided on one side of the front surface of the cabinet 100 to be easily controlled by the user. Here, in this embodiment, the power button 102 is provided on the lower surface of the front surface of the cabinet 100. However, the position of the power button 102 is not limited thereto, and may be provided on the left or right of the front surface of the cabinet 100, or on any suitable location for example.

The cabinet 100 may include a cover connection unit 104 connected to the cover 300. The cover connection unit 104 may correspond to an edge of the opened front surface of the cabinet 100 and may have a smaller diameter than the diameter of the cover 300 so that the cover 300 is not detached from the cabinet 100. Specifically, the cover 300 may be inserted into the cabinet 100 from the rear surface to the front surface side. In this case, since the diameter of the cover connection unit 104 is smaller than the diameter of the cover 300, the cover 300 may be fitted into the cover connection unit 104, so that the cover 300 may not separate from the cabinet 100.

The cabinet 100 may include a rear panel connecting unit 106 connected to the rear panel 800. The rear panel connecting unit 106 may correspond to the opened rear edge of the cabinet 100 and may be have the same shape of the rear panel 800. The cabinet 100 may be bolted to the rear panel 800 and for this purpose, a plurality of bolt fastening holes may be formed in the rear panel connecting portion 106

Meanwhile, the door 200 may be provided on the front surface of the cabinet 100. The door 200 is provided for loading and unloading laundry, and may include a door inner frame 230 and a door outer frame 240. Specifically, the door inner frame 230 and the door outer frame 240 may be bolted to have a predetermined space therebetween, and each may have a circular shape with a diameter corresponding to the cover connection unit 104. In this case, the door inner frame 230 may be in contact with the cover connection unit 104, and the door inner frame 230 and the door outer frame 240 may completely shield, e.g., protect, the cover 300 connected to the cabinet 100.

The door inner frame 230 and the door outer frame 240 may include a door hinge connection unit 232 for connecting with the cover 300. The door hinge connecting unit 232 is disposed at one side of the door inner frame 230 and the door outer frame 240 and may provide a space for accommodating a door hinge 360 of the cover 300 (to be described later).

A display 202 may be provided in a space located between the door inner frame 230 and the door outer frame 240. The display 202 is capable of outputting predetermined information to the user, and is provided with a front surface exposed to the outside of the door outer frame 240. That is, the door outer frame 240 may include a hole (not shown) or may be formed of a transparent material so that the display 202 may be exposed and viewable. In this case, the display 202 may be a touch panel capable of inputting or outputting information, and the user may confirm the information such as the operating state through the display 202, also invoke an operation of the wall-mounted washing machine 10 via touch operations. For example, the user may select a cycles such as laundry washing and rinsing by performing a touch operation with respect to the display 202, and confirm the remaining washing time or the like through visualization of the display 202.

The display 202 which is exposed to the exterior of the door outer frame 240 and the door outer frame 240 may be protected through a protective glass 204. The protective glass 204 is transparently and disposed on the front surface of the door outer frame 240 so that the user may visualize the display 202. In this case, the protective glass 204 may have the same diameter as the door inner frame 230 and the door outer frame 240.

A hole (not shown) may be provided on one side of the protective glass 204, and the door opening button 210 may be exposed to the outside through the hole (not shown). The door opening button 210 may be provided in the door outer frame 240 for opening or closing the interior of the cabinet 100 using an electronic opening and closing system and may be exposed to the outside through a hole of the protective glass 204.

In addition, the door 200 may include a door opening unit 250 and a door hanging unit 260. The door opening unit 250 and the door hanging unit 260 may protrude rearward of the door inner frame 230 and may be in contact with and engaged with one side of the cover 300. Specifically, the door opening unit 250 serves as an opening/closing assistant and may have an elastic force. For example, the door opening unit 250 may include a spring and may act as a force support for opening the door 200 through the elastic force of the spring. For example, when the door 200 is closed, the door opening unit 250 may be compressed and inserted into a groove (not shown) provided on one side of the cover 300. When the user operates the door opening button 210 to open the door 200, the door opening unit 250 may release from one side of the cover 300, and may be in contact with the bottom surface of the groove (not shown) provided on one side of the cover 300 in a relaxed state. That is, a space is provided between the door 200 and the cover 300 by the relaxed length of the door opening unit 250, thereby preventing the door 200 from being automatically closed.

The door opening unit 250 may be a pusher stem assembly that may be supported by the spring and located within a guide structure formed in the door inner frame 230 to repeatedly perform projecting by a linear movement to a predetermined stroke range.

The door hanging unit 260 may be disposed at a predetermined distance from the door opening unit 250 and may have the shape of a hook partially protruding from the door inner frame 230. The protruding portion of the door hanging unit 260 may be coupled to a door lock unit 330 of the cover 300 (to be described later), and thus the door 200 may be closed securely.

In summary, the door 200 according to one embodiment of the present disclosure may be opened through a door opening button 210. When the user operates the door opening button 210, the door opening unit 250 and the door hanging unit 260 may be released from the cover 300 so that the door 200 may open the cover 300. In this case, the door opening unit 250 having an elastic force may be relaxed and disposed on one side of the cover 300, and thus a predetermined gap is provided between the door 200 and the cover 300. Therefore the door 200 may be prevented from closing.

In addition, the user may close the door 200 by applying pressure to the door 200 toward the cover 300 side. To this end, the user may press one side of the outermost protective glass 204 of the door 200 thereby compressing the door opening unit 250 and pushed in the groove (not shown) of the cover 300 and the protruding portion of the door hanging unit 260 may be coupled to the door hanging unit 330 of the cover 300. That is, the door 200 may be opened and closed without using a separate handle.

A center side of the door inner frame 230 and the door outer frame 240 may be opened and the door glass 280 may be provided at the opened center side. The door glass 280 is provided for user visualization of the laundry inside the washing machine 10 from the outside of the washing machine 10 and may be fitted to the door inner frame 230 and the door outer frame 240. In this case, the door glass 280 may be formed to protrude rearward, and the protruded side of the door glass 280 may be fitted to the opened side of the cover 300.

Meanwhile, the door 200 may be rotatably connected to the cover 300. The cover 300 is provided to enclose the front panel 400 and may include a laundry inlet 302 for loading laundry, a detergent container loading port 304 for loading a detergent container 500, and a power processing unit 306 for controlling the button 102.

The user may load laundry through the laundry inlet 302. The laundry inlet 302 may have a predetermined diameter. In this case, the diameter of the laundry inlet 302 may correspond to the size of the protruding portion of the door glass 280. Thus, when the door 200 is closed, the door glass 280 may block the laundry inlet 302, and when the user opens the door 200, the door glass 280 is released from the laundry inlet 302 so that the laundry loading through the laundry inlet 302 may be possible.

A detergent container loading port 304, which may load the detergent container 500, may be disposed on the upper side of the laundry inlet 302. In this case, the detergent container loading port 304 may be formed to correspond to the shape of the detergent container 500.

The cover 300 may have a laundry inlet 302 at its center and may have a circular shape as a whole. Further, the cover 300 may have a shape in which one side protrudes downward. In this case, the power processing unit 306 may be disposed in a protruding portion downward. The power processing unit 306 may be a PCB substrate connected to the power button 102 to control whether the power is turned on or off according to the operation of the power button 102 protruding from the outside of the case 100.

The cover 300 may include a door hanging unit 330 at a position corresponding to the other door hanging unit 260. The door hanging unit 330 is coupled to the hook-shaped door hanging unit 260 and may be a groove corresponding to the shape of the door hanging unit 260. Thus, as the door hanging unit 260 is coupled to the door hanging unit 330, so that the door 200 may close the laundry inlet 302.

Also, the cover 300 may include a door hinge 360 disposed at a location corresponding to the door hinge connection unit 232. The door hinge 360 may be provided to be opened while one side of the door 200 and one side of the cover 300 may be connected to each other, and the one side of the door hinge 360 may be received in the door hinge connection unit 232. Specifically, the door hinge 360 may have a shape of a long curved panel in a vertical direction on one side of the laundry inlet 302, and may partially protrude forward such that the door 200 may be rotated and connected to the door hinge connection unit 232. That is, the door 200 may be rotatable along the protruding portion in front of the door hinge 360.

A front panel 400 may be provided on the rear surface of the cover 300. The front panel 400 may be coupled to the tub 700 and may include a shield unit 410 shielding a space between the drum 600 and the tub 700, a detergent container receiving unit 420 receiving the detergent container 500, a detergent container gasket 430 provided to seal at a portion coupled with the detergent container 500, a fitting 440 for supplying water into the detergent container 500, a door gasket 450 provided to seal at a portion in contacted with the door 200, and a water supply valve assembly 480 for receiving wash water from an external water supplying source.

The shield unit 410 may shield a space formed between the drum 600 and the tub 700 and may have a shape corresponding to the cover 300. That is, it may have the same diameter as the cover 300 and have an opening corresponding to the laundry inlet 302 provided on the center side thereof. In this connection, the opening of the shield unit 410 may be smaller than the diameter of the drum 600, so that the space between the drum 600 and the tub 700 may be shielded.

The detergent container receiving unit 420 may be disposed at one side of the shield unit 410 to receive the detergent container 500. The detergent container receiving unit 420 may be provided in a shape corresponding to the detergent container 500 and may be communicated with the detergent container loading port 304 of the cover 300. That is, the detergent container 500 may be received in the detergent container receiving unit 420 via the detergent container loading port 304 of the cover 300.

The detergent container receiving unit 420 may include a detergent container gasket 430 that is pressurized by the detergent container 500. The detergent container gasket 430 may be disposed around the end of the detergent container receiving unit 420 to seal the detergent container 500 and may be provided as a rubber material. That is, the detergents, the conditioners, and the wash water supplied to the detergent container 500 are prevented from leaking to the outside through the detergent container gasket 430.

At least one fitting 440 may be provided on the top of the detergent container receiving unit 420. The fitting 440, which is connected to a water supply valve assembly 480 connected to an external water supply source, may supply the wash water into the detergent container 500. Thus, the wash water supplied to the drum 600 and the tub 700 includes the dissolved detergents or conditioners as a result of the wash water being supplied into the drum 600 and the tub 700 through the detergent container 500.

The opening of the shield unit 410 may include a door gasket 450 which is pressed against a door glass 280 of the door 200. The door gasket 450 may be disposed at the opening end of the shield unit 410 (for example, at the annular end of the opening) to hermetically fix the door glass 280, and it may be composed of a rubber material or the like. Thus, when the door 200 is closed, the door glass 280 penetrating the laundry inlet 302 of the cover 300 presses against the door gasket 450, and thereby the wash water inside the drum 600 and the tub 700 is prevented from leaking outside the door 200.

The fitting 440 may be supplied with wash water through a water supply valve assembly 480. The water supply valve assembly 480 may be connected to an external water supply source and may selectively supply the wash water to the detergent container 550 through the fitting 440. The water supply valve assembly 480 may be a three-way valve and two of the supply flow paths extending from the water supply valve assembly 480 may be connected to the fitting 440 connected to the detergent container 500 and one of them may supply the wash water to the drum 600 directly through the door gasket 450.

The detergent container 500 may accommodate detergent and conditioner and may include a detergent container handle 502, a detergent input space 504 in which detergents are loaded, and a conditioner input space 506 in which a conditioner is loaded.

The detergent container handle 502 may protrude forward and may be exposed to the outside of the cover 300. The user thus may grasp the detergent container handle 502 after opening the door 200, allowing the detergent container 500 to be unloaded or inserted from the detergent container receiving unit 420. In this embodiment, although the detergent container handle 502 is extended in the vertical direction and provided at the center of the front surface of the detergent container 500, the detergent container handle 502 is not limited to this orientation. For example, the detergent container receiving unit 420 may be extended in the horizontal direction and provided on the front surface of the detergent container 500.

The detergent container 500 may be partitioned based on the center of the interior and include a detergent input space 504 and a conditioner input space 506 for storing detergents and conditioners, respectively. In this connection, the fitting 440 may be arranged to correspond to the detergent input space 504 and the conditioner input space 506, and the detergents and conditioners in the detergent input space 504 and the conditioner input space 506 may be missed with the wash water. Specifically, the user may draw the detergent container 500 from the detergent container receiving unit 420 after opening the door 200 and may fill detergent and conditioner into the detergent input space 504 and the conditioner input space 506, respectively. The detergent container 500 filled with the detergent and the conditioner may be inserted again into the detergent container receiving unit 420, and depending on the washing process, the detergent input space 504 and the conditioner input space 506 may be supplied with the wash water. Accordingly, the wash water including mixed detergent or conditioner may be selectively supplied to the drum 600 and the tub 700.

Meanwhile, the front panel 400 may be connected to the drum 600. The drum 600 for receiving laundry may include a drum inlet 610 on the front surface and a spider 680 on the rear surface. In this case, a plurality of holes for fluid communication with the tub 700 may be formed around the drum 600.

A drum inlet portion 610 may be provided to correspond to the opened portion of the shield unit 410. In this connection, the drum inlet portion 610 may have a diameter smaller than the entire diameter of the drum 600, and the drum inlet portion 610 may be fitted into the opened portion of the shield unit 410, so that front panel 400 and the drum 600 may be connected to each other. Thus, laundry may be loaded into the drum 600 via the laundry inlet 302 of the cover 300 and the opened portion of the front panel 400.

The drum 600 may be rotated through a spider 680 device. The spider 680 may rotate in response to a driving force of a driving motor 910 to be described later. The spider 680 may be provided separately from the drum 600 and coupled to the rear surface of the drum 600. In this case, a groove corresponding to the shape of the spider 680 may be formed on the rear surface of the drum 600 so that the spider 680 may be seated.

The spider 680 may include a plurality of arms extending in different directions with a constant gap at the center. For example, the spider 680 may include an arm extending in three directions by a length corresponding to the radius of the drum 600, and each arm may be disposed at a 120-degree gap. Further, the center of the spider 680 may be fixed to a second pulley 914 (to be described later) through a drum rotation axis 916 (to be described later), and thus the drum 600 coupled to the spider 680 and the spider 680 may be rotated. A specific method of rotating the drum 600 will be described later.

A tub 700 in which the wash water is filled may be provided outside the drum 600. The tub 700 may have a shape corresponding to the drum 600 and may be formed to have a diameter larger than a diameter of the drum 600 by a predetermined length. Accordingly, the tub 700 may be arranged apart from the drum 600 by a predetermined gap. In addition, the wash water supplied into the tub 700 may flow into the drum 600 through a plurality of holes formed around the drum 600. Similarly, the inner wash water of the drum 600 may flow into the tub 700 through the plurality of holes formed around the drum 600. In this regard, the drum 600 and the tub 700 may be provided in a cylindrical shape, but are not limited thereto.

Further, the tub 700 may include a heater 702 to heat the wash water. Specifically, a groove may be formed on the inner side of the tub 700 to receive the heater 702, and the heater 702 may be provided on the inner side of the tub 700 in a detachable manner. Thus, the heater 702 may heat the wash water filled in the tub 700.

Meanwhile, the tub 700 may be integrally provided with a rear panel 800. The rear panel 800 may be mounted on the wall and may include an anchor connection unit 802 to which an anchor for connecting to the wall is connected, a cabinet fixing unit 804 for fixing the cabinet 100, and a sensor 806 for detecting the water level.

Specifically, the tub 700 and the rear panel 800 may be integrally injection molded, and the tub 700 may protrude from the front of the rear panel 800. The rear surface of the rear panel 800 may be mounted on the wall via a separate anchor. The anchor may be coupled to the wall (or other vertical surface) through an anchor connection unit 802 and may be provided on the rear surface of the rear panel 800 for stable engagement. That is, the plurality of anchors may mount the rear panel 800 on the wall. In this case, since the tub 700 and the rear panel 800 are integrally provided, a separate damper or an elastic member for supporting the tub 700 is not required. Consequently, the number of parts may be reduced, and the size of the washing machine 10 may be reduced.

The cabinet 100 may be coupled to the front surface of the rear panel 800 where the tub 700 is provided to enclose the tub 700. In this case, a cabinet fixing unit 804 may have a stepped shape along the periphery of the rear panel 800, and the cabinet 100 may be fixed to the cabinet fixing unit 804. For this purpose, a fastening member such as a bolt may be used.

Also, the rear panel 800 may include a control unit 810 for controlling the overall functions of the wall mounted washing machine 10 and a drain unit 820 for discharging the wash water filled in the tub 700.

The control unit 810 may be disposed on the front surface of the rear panel 800 to control various components of the wall mounted washing machine 10 depending on a user's operation to perform laundry washing. In this embodiment, while the control unit 810 is shown on the right side of the respect to tub 700, the position of the control unit 810 is not limited thereto.

A power supply line 904 may be connected to the external power source to supply power to the electric equipment, the control unit 810, the driving motor 910, and the like described above. The power supply line 904 may extend through the rear panel 800 to the front of the rear panel 800 and may extend outwardly from the rear of the rear panel 800. In this case, the power supply line 904 may be fixed to the rear surface of the rear panel 800 through a separate fixing means. As the power supply line 904 is provided extending outwardly from the rear surface of the rear panel 800, the appearance of the washing machine 10 is improved.

The drain unit 820 may be disposed under the rear panel 800. The drain unit 820 may discharge the wash water inside the tub 700 to the outside and may be provided on the lower surface of the front surface of the rear panel 800. In this case, the drain unit 820 may include a drain pump for pressurizing the wash water and may be connected to the drain hose 902 to discharge the wash water. Specifically, the drain hose 902 is connected to the drain unit 820 and extends outward along the rear surface of the rear panel 800, so that the wash water may flow under the pressure of the drain unit 820. Thus, when the drain unit 820 is operated after the washing cycle is completed, the wash water can be discharged to the outside of the cabinet 100 through the drain hose 902 due to the pressure change of the drain unit 820.

The rear panel 800 may include a driving motor 910 for transmitting a driving force to the rear panel 800, a first pulley 912 and a second pulley 914 connected to the driving motor 910, a drum rotational shaft 916 connected to the second pulley 914 to rotate the drum 600, and a belt 918 that connects the first pulley 912 and the second pulley 914.

Specifically, the driving motor 910 may be provided on the front surface of the rear panel 800. The driving motor 910 may be controlled by the control unit 810 and may be provided on one side of the control unit 810 and the drain unit 820.

Also, the driving motor 910 may be connected to the first pulley 912. In this case, the shaft (not shown) of the driving motor 910 may be provided through the rear panel 800 and may be connected with a shaft (not shown) of the driving motor 910 the first pulley 912 at the rear surface of the rear panel 800.

The first pulley 912 may be connected to the second pulley 914 via a belt 918. The second pulley 914 may be provided to surround the drum rotation shaft 916 connected to the spider 680 and the drum rotation axis 916 may penetrate the rear panel 800 while being connected to the spider 680. That is, the second pulley 914 and the drum rotation shaft 916 may be connected to each other at the rear surface of the rear panel 800.

In summary, when the wash water is filled in the tub 700 through the fitting 440, the control unit 810 may operate the driving motor 910. Subsequently, the first pulley 912 connected to the driving motor 910 may be rotated, and the second pulley 914 may be then rotated by the rotation of the first pulley 912. Thus, the drum rotation shaft 916 connected to the second pulley 914 may also rotate so that the drum 600 may be rotated inside the cabinet 100 and the tub 700. Consequently, the laundry inside the drum 600 may be washed.

On the other hand, the rear panel 800 may further include an exhaust line 920. The exhaust line 920 may be connected to the drain unit 820 and may exhaust air inside the tub 700 and the drain unit 820. Specifically, the exhaust line 920 may be connected to the drain hose 902 and pass through the rear panel 800, through which it may extend to the rear surface of the rear panel 800 and exhaust to the outside.

The wall-mounted washing machine 10 according to an embodiment of the present disclosure may be used as follows.

First, the user may open the door 200, and may load the laundry inside the drum 600 and unload the detergent container 500 from the front panel 400. In this case, the detergent container 500 is divided in the center, so that a space for loading detergent and conditioner, respectively, may be provided.

After inserting the detergent container 500 loaded with detergent and conditioner back into the front panel 400, the user may close the door 200 and control the laundry operation via the power button 102 and the display 202. When the washing operation is started, the wash water provided from an external water supplying source through the water supply valve assembly 480 may be supplied to the detergent container 500 through the fitting 440, and the wash water may be supplied into the drum 600 and tub 700 after passing the detergent input space 504 and the conditioner input space 506. That is, the wash water filled in the drum 600 and the tub 700 may optionally include detergent and conditioner.

When the tub 700 is fully filed with the wash water, the control unit 810 may drive the driving motor 910. In this case, the driving motor 910 may be connected to the first pulley 912 and the second pulley 914, and the second pulley 914 may be connected to the drum 600 through the drum rotation shaft 916. Thus, the drum 600 may be rotated through the driving motor 910. Consequently, the laundry loaded in the drum 600 may be easily washed by the rotation of the drum 600.

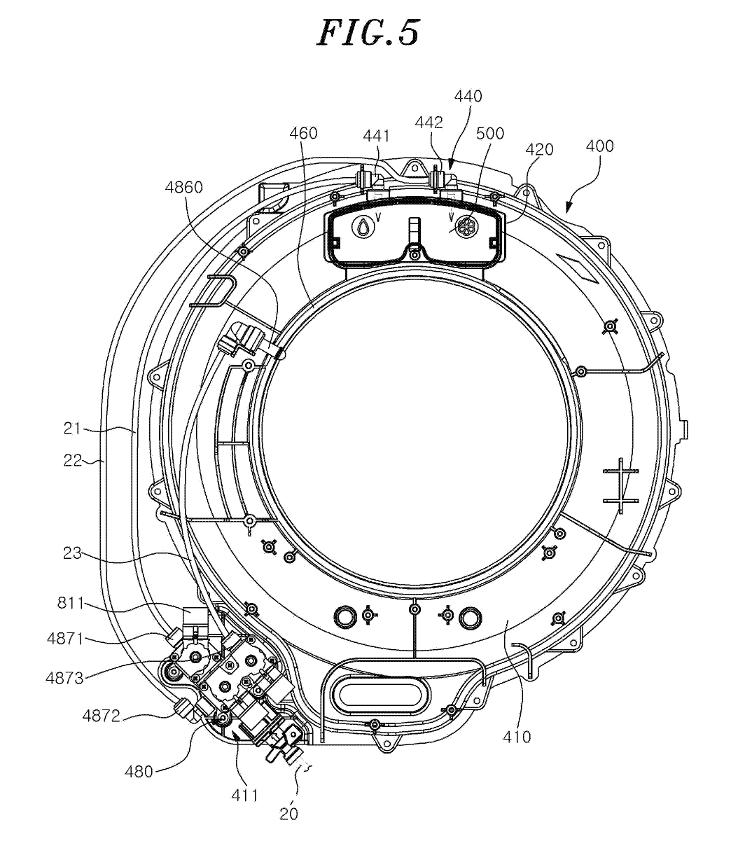

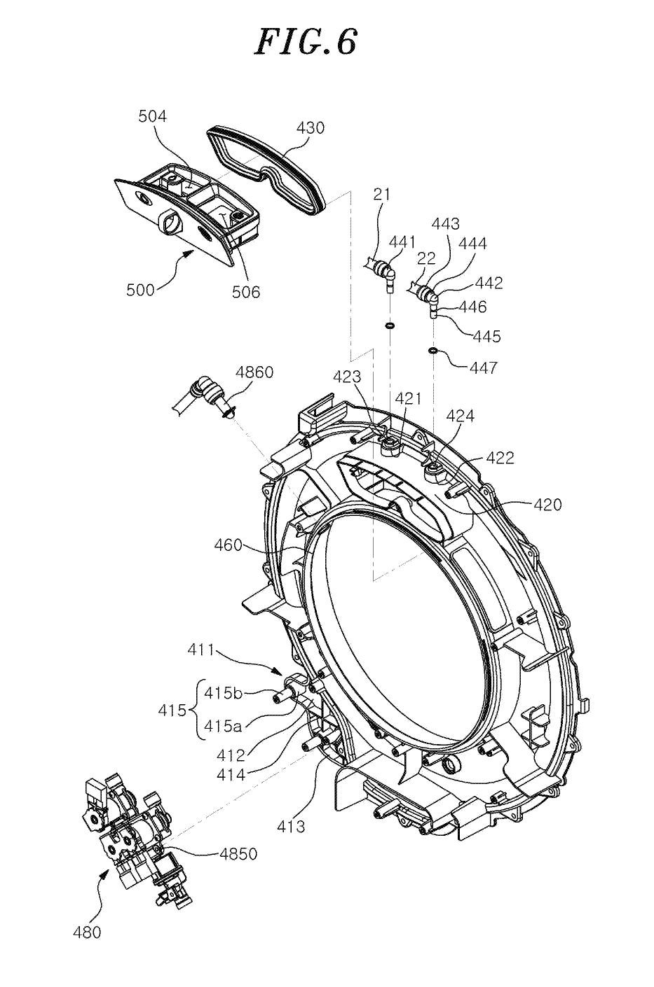

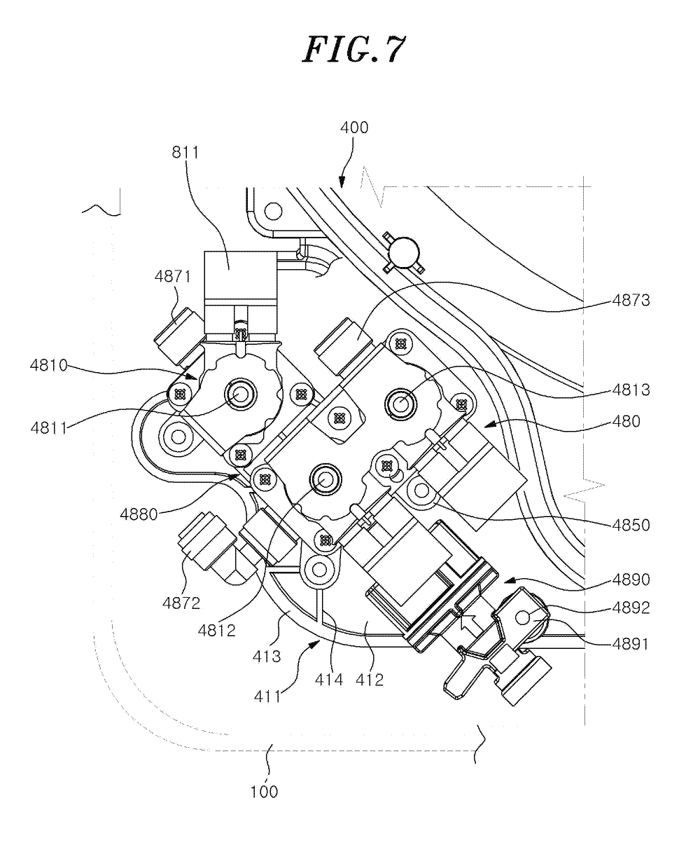

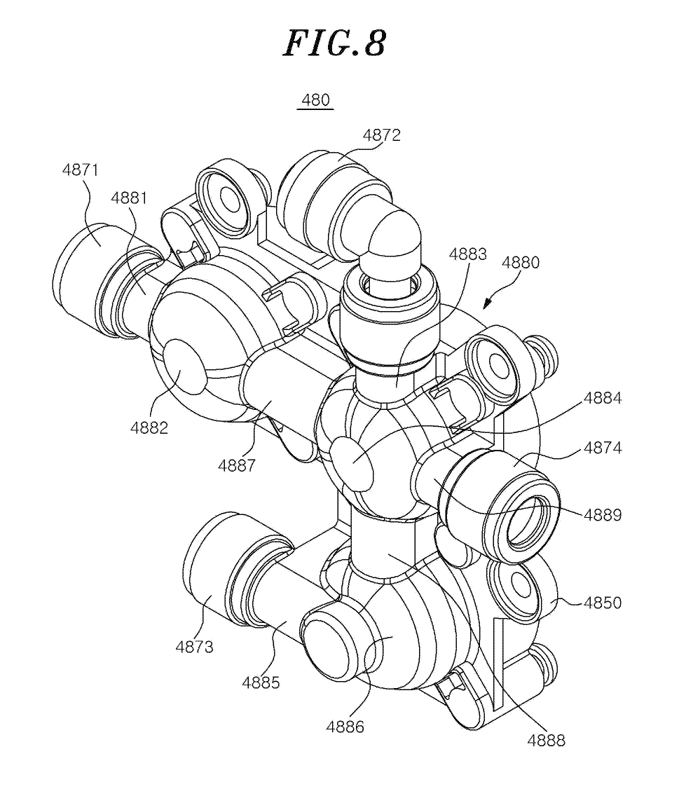

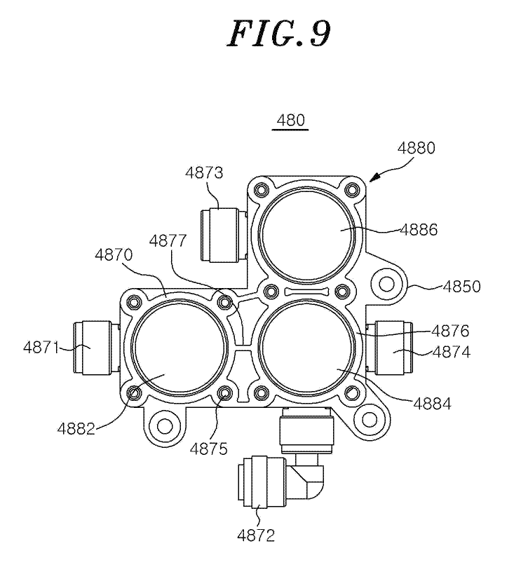

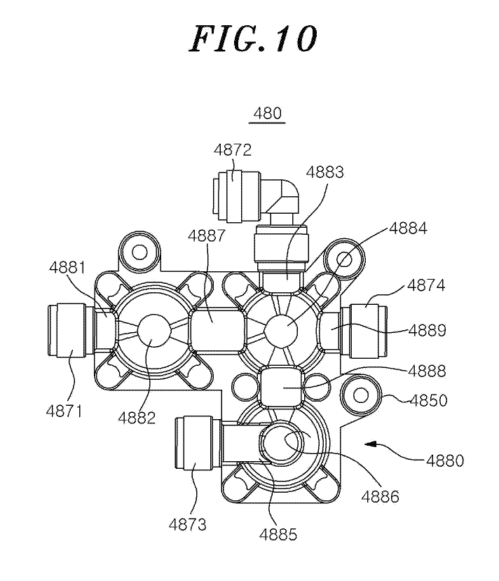

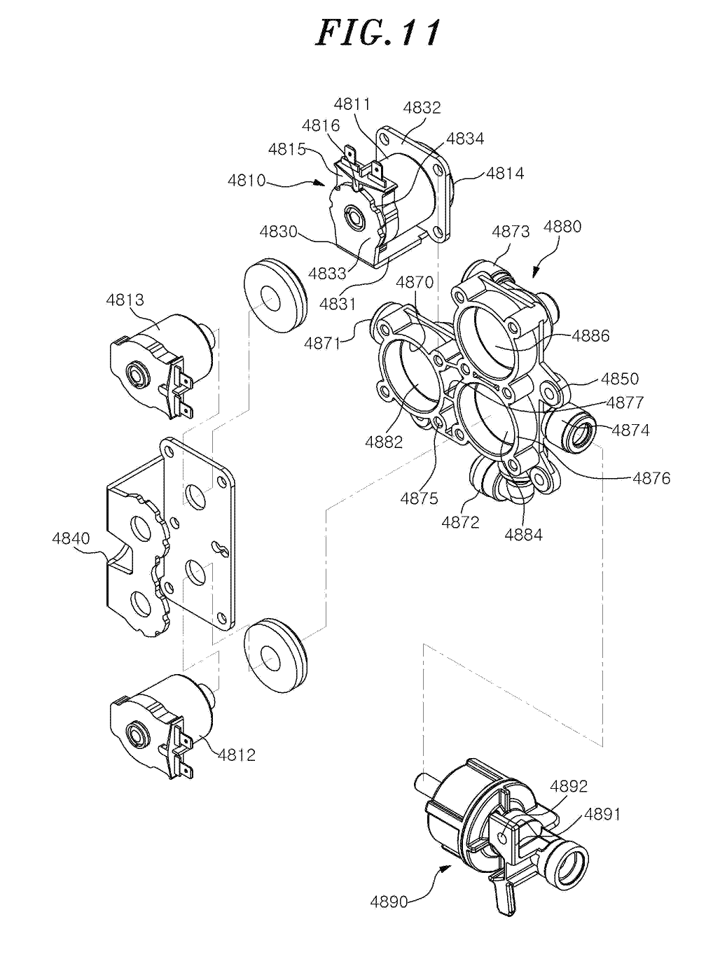

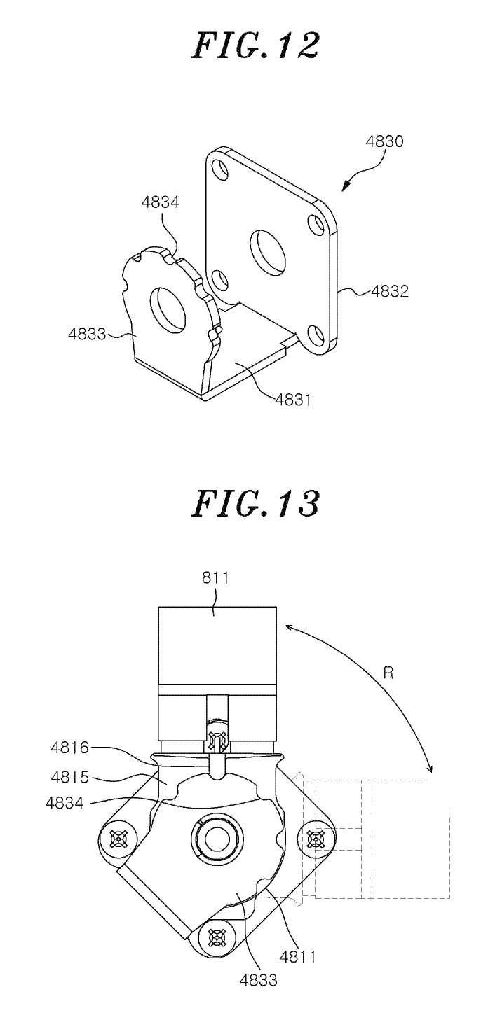

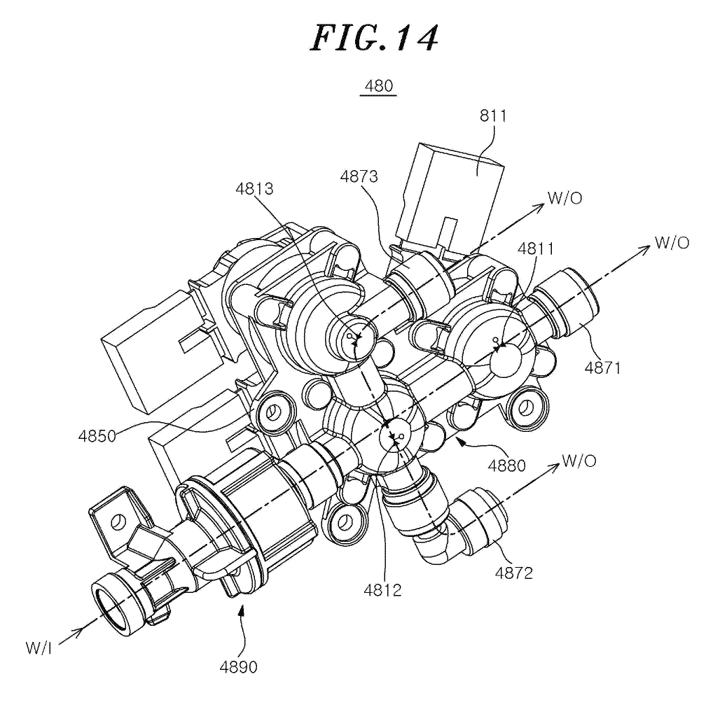

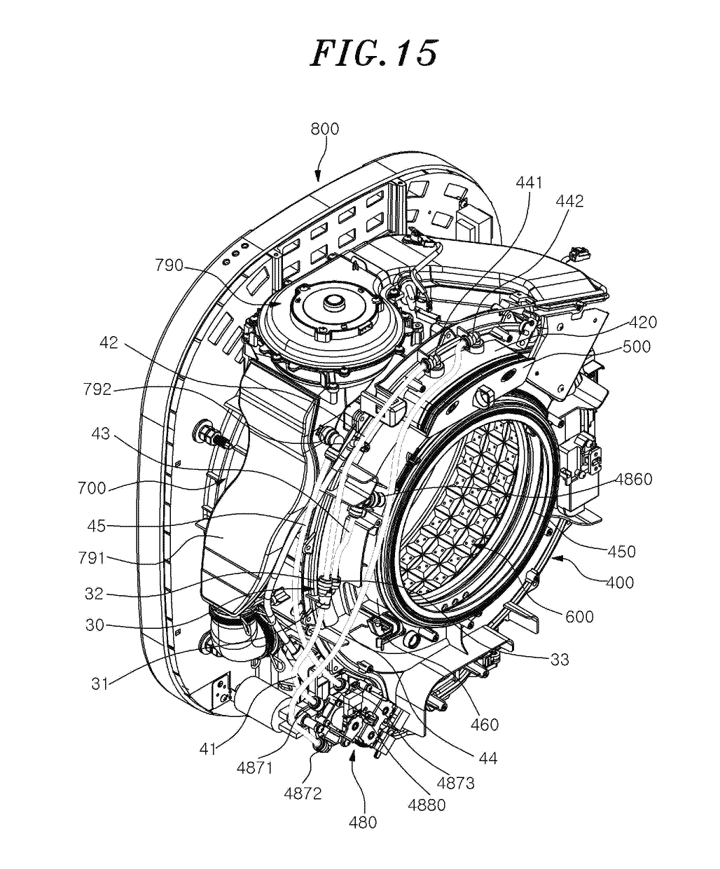

FIG. 5 is a front view of the front panel of FIG. 4, FIG. 6 is an exploded perspective view of the front panel shown in FIG. 5, and FIG. 7 is a front view enlarging a state in which a water supply valve assembly is installed on the front panel of FIG. 6. Further, FIG. 8 is a rear perspective view of the water supply valve assembly shown in FIG. 7, FIG. 9 is a front view of the valve body of the water supply valve assembly of FIG. 8, and FIG. 10 is a rear view of the valve body of FIG. 9. In addition, FIG. 11 is an exploded perspective view of the water supply valve assembly shown in FIG. 6, and FIG. 12 is a perspective view of the single bracket shown in FIG. 11. Also, FIG. 13 is a front view in which a first control valve is coupled to the single bracket shown in FIG. 12, and FIG. 14 is a rear perspective view for explaining valve operations of a water supply valve assembly.

Referring to FIGS. 5 to 14, the front panel 400 includes a fitting 440 and a water supply valve assembly 480 as structural features to minimize any water leaking points and a supply water line structure supplied through the pipes 20, 21, 22, and 23

Referring to FIG. 5, the water inlet pipe 20 is connected to a water inlet side of the water supply valve assembly 480.

The pipes 21, 22 and 23 for sending to a plurality of places are connected at the water outlet side of the water supply valve assembly 480.

For example, the pipes 21, 22 and 23, which are coupled through the fitting 440, that is, the first fitting 441 or the second fitting 442, may be any one of a tube, a pipe, and a hose.

The pipes 21, 22 and 23 may be made of a flexible material or a flexible plastic material capable of bending or other deformation.

Further, the first pipe 21 interconnects a first water outlet unit 4871 of a valve body 4880 of the water supply valve assembly 480 and the first fitting 441 of the detergent container receiving unit 420.

Further, the second pipe 22 interconnects a second water outlet unit 4872 of the valve body 4880 and the second fitting 442 of the detergent container receiving unit 420.

Further, the third pipe 23 interconnects a third water outlet unit 4873 of the valve body 4880 and a water jet nozzle 4860 of the front panel 400.

The water jet nozzle 4860 directly discharges the water toward the inside space of the drum 600 or the laundry inside the drum 600.

To this end, the water jet nozzle 4860 may be installed in a nozzle mounting hole arranged in the opening 460 (see FIG. 6) of the front panel 400 and the door gasket 450. In this case, the nozzle hole of the water jet nozzle 4860 (through which the water is discharged) passes through the body of the door gasket 450 with respect to the inside position of the opening 460 of the front panel 400, and is opened toward the inner space of the drum 300.

In addition, the water supply valve assembly 480 is provided on the front panel 400 to efficiently utilize the space for installing parts inside the washing machine.

To this end, the front panel 400 includes an extension 411 integrally formed on the lower side of the front panel 400 to install the water supply valve assembly 480.

The extension 411 is integrally formed on the left corner of the front panel 400 at the lower corner of the front panel 400.

For example, the extension 411 includes a base plate 412 extending from the side surface of the front panel 400 and a base wall 413 extending along the outer periphery of the base plate 412, as shown in FIG. 7.

Further, the extension 411 includes a plate reinforcing rib 414 that connects the base wall 413 to each other and protrudes from the base plate 412.

Moreover, referring to FIGS. 6 and 7, the extension 411 includes a plurality of supports 415 protruding from the extension 411 with respect to the base plate 412, the base wall 413 and the plate reinforcing rib 414.

The extension 411 may be integrally formed with the base plate 412, the base wall 413, the plate reinforcing ribs 414, and the support 415 during injection molding of the front panel 400.

In addition, the bolt holes are formed in each end of the support 415 so that the water supply valve assembly 480 may be detached in a bolted manner. Herein, the bolt holes of the support 415 are formed at the ends of the support 415 toward the water supply valve assembly 480, respectively.

In addition, the support 415 of the extension 411 is spaced apart from the base plate 412 or the plate reinforcing ribs 414 such that the water supply valve assembly 480 may be disposed in an oblique direction with respect to the front surface of the front panel 400 in the extension 411.

Meanwhile, the water supply valve assembly 480 includes a supporting leg 4850 fastened to each of the bolt holes of the support 415.

The supporting leg 4850 protrudes from the outer side of the valve body 4880 of the water supply valve assembly 480 to cover the upper end of the support 415.

The number and arrangement of the supporting legs 4850 of the water supply valve assembly 480 may be determined corresponding to the number and arrangement of the supports 415.

In addition, the support 415 has a protruding height that allows the water supply valve assembly 480 to be spaced from the base plate 412 or the plate reinforcing rib 414.

The support 415 may include a support base 415a integrally formed with the base plate 412 or the plate reinforcing rib 414; and a support extension 415b having a small diameter relative to the support base 415a and thus a step difference, and protruding from the support base 415a toward the water supply valve assembly 480. Herein, the bolt hole of the support 415 refers to a bolt hole formed at the end of the support extension 415b.

The mounting bolts of the water supply valve assembly 480 may pass through the holes of the supporting legs 4850 of the water supply valve assembly 480 and then screwed into the bolt holes formed in the end of the support extension 415b, which allows the valve assembly 480 to be detachably secured to the support 415.

Thus, the fixed water supply valve assembly 480 is disposed along the upward slanting direction from the extension 411 with respect to the horizontal direction of the front surface of the front panel 400. As a result, it is possible to remove the inner surface and the interference of the cabinet 100, and therefore the space for installing the parts inside the washing machine may be utilized efficiently.

As described above, the front panel 400 includes the extension 411 formed on the lower side of the extension 411 and a detergent container receiving unit 420 formed on the top relative to the extension 411 or on the upper portion of the front panel 400 to receive the detergent container 500.

The detergent container 500 may be detachably coupled to the detergent container receiving unit 420 in an insertion manner or a sliding manner.

Herein, the front surface and the rear surface of the detergent container receiving unit 420 are opened along the direction in which the detergent container 500 is advanced or fastened.

In addition, the detergent container 500 includes a detergent input space 504 and a conditioner input space 506 divided with respect to the diagonal partition to accommodate detergents and conditioners.

The detergent container receiving unit 420 includes a first fitting mounting unit 421 protruding from one side of the upper surface of the detergent container receiving unit 420 with respect to the position where water supplied to the detergent input space 504.

Further, the detergent container receiving unit 420 includes a second fitting mounting unit 422 protruding from the other side of the upper surface of the detergent container receiving unit 420 with respect to the position where the water is supplied to the conditioner input space 506.

The first fitting mounting unit 421 and the second fitting mounting unit 422 may support the first fitting 441 or the second fitting 442, by fixing them by friction, and preventing leakage from occurring inside the washing machine.

The first fitting mounting unit 421 and the second fitting mounting unit 422 are provided with fitting holes 423 and 424 formed thereon.

The first fitting 441 or the second fitting 442 (corresponding to the fitting of the pipes 21 and 22 for supplying water) is coupled to the fitting holes 423 and 424.

The fitting holes 423 and 424 vertically extend from the center of each of the first fitting mounting unit 421 and the second fitting mounting unit 422 to allow the water to flow through the upper surface of the detergent container receiving unit 420.

In addition, the first fitting 441 or the second fitting 442 may be an elbow type pipe member which is coupled between the end of the pipes 21 and 22 and the fitting holes 423 and 424.

Each of the first fitting 441 and the second fitting 442 includes a pipe fastening unit 443 coupled with each end of the pipes 21 and 22 and a horizontal hollow portion 444 penetrating the pipe fastening unit, and a vertical hollow portion 445 through-connected to the horizontal hollow portion 444 and inserted into the corresponding fitting holes 423 and 424.

In this case, an O-ring mounting groove 446 is formed on the outer peripheral surface of the vertical hollow portion 445 of each fitting 441 and 442.

Each of the fittings 441 and 442 includes an O-ring 447. The O-ring 447 may be coupled to the O-ring mounting groove 446 to eliminate the gap between the inner peripheral surface of the fitting holes 423 and 424 and the outer peripheral surface of the vertical hollow portion 445 of each fitting 441 and 442, so that water-tightness and fixing performance may be improved.

Further, each of the fittings 441 and 442 has the same level as a bottom end of the vertical hollow portion 445 of each of the fittings 441 and 442 and a bottom end of the fitting holes 423 and 424. Thus, when the detergent container 500 is inserted into the detergent container receiving unit 420, the detergent container 500 and the fittings 441 and 442 do not interfere with each other.

A fluid such as water or wash water from an external water supplying source may be introduced or fed into the water inlet pipe 20 and water supply valve assembly 480 by the fluid pressure of the external water supplying source.

The fluid may then flow through the various pipes 21, 22 and 23 at the water outlet side of the water supply valve assembly 480 by fluid pressure.

Since the water supply valve assembly 480 is supported on the support 415 and spaced apart from the extension 411, it is very easy to install, check the state of the installation, and maintain the water supply valve assembly 480.

Each of the control valves 4810 may be a plurality of solenoid valves or electromagnetic valves electrically connected to the control unit 810 of FIG. 4 and installed in the water supply valve assembly 480.

That is, each of the control valves 4810 may be installed on fluid paths required for the supply or interruption of water in the fluid path in the washing machine. For example, each of the control valves 4810 may be integrated with the water supply valve assembly 480 with respect to the fluid path.

Referring to FIG. 15 according to an exemplary application of the present disclosure, the wall mounted washing machine includes a rear panel 800 mounted on a wall (not shown), a tub 700 supported by the rear panel 800 and filled with wash water, and a control unit (810) installed outside the tub 700. Further, the wall mounted washing machine includes a front panel 400 provided with an opening 460 and installed in the tub 700, and a drum 600 rotatably installed in the tub 700.

In particular, the wall mounted washing machine according to the exemplary application of the present disclosure includes a drying unit 790 installed outside the tub 700 and supplying air into the drum 600.

The drying unit 790 includes a drying duct 791 corresponding to an air passage.

Here, the water supply valve assembly 480 is installed at the front panel 400 with respect to the inner lower space of the cabinet 100, and at least one of the tub 700, the drum 600 and the drying unit 790 may selectively supply the water.

The water supply valve assembly 480 further includes a pipe coupler 4890 connecting the water inlet side of the valve body 4880 and the water inlet pipe 20 to allow the water to flow.

Moreover, the pipe coupler 4890 may be connected to the water inlet portion 4874 corresponding to the water inlet side of the valve body 4880.

The water supply valve assembly 480 may be a three-way valve that discharges water or wash water from the water inlet 4874 through three water outlet units.

In addition, the pipe coupler 4890 may be a quick coupling pipe member for precisely connecting tubes, pipes, hoses, and the like.

The pipe coupler 4890 includes a coupler fixing unit 4891 protruding from the surface of the pipe coupler 4890 to be fixed to the extension 411 of the lower side of the front panel 400 by a bolt. Herein, a bolt fastening hole is formed in the coupler fixing unit 4891.

Thus, the pipe coupler 4890 and the water inlet pipe 20 connected thereto may be securely mounted to the extension 411 of the front panel 400 through the coupler fixing unit 4891.

Referring to FIG. 7, the control valve 4810 collectively includes a first control valve 4811, a second control valve 4812, and a third control valve 4813.

The first control valve 4811 is responsible for supplying or blocking water to the detergent input space 504 of the detergent container 500.

The second control valve 4812 is responsible for supplying or blocking water to the conditioner input space 506 of the detergent container 500.

The third control valve 4813 is responsible for supplying or blocking water to/from the water jet nozzle 4860 installed at the opening 460 of the front panel 400 or for supplying or blocking water to/from the drying duct 791 of the drying unit 790.

Referring to FIGS. 8 to 10, the water supply valve assembly 480 includes a valve body 4880.

The valve body 4880 is coupled and installed to the support 415 by a bolt to be supported on the support 415 described above.

The role of the valve body 4880 serves to allow the water supplied to the water supply valve assembly 480 to be provided to the detergent input space 504 of the detergent container 500 or otherwise the water to be provided to the divided conditioner input space 506 from the detergent input space 504 as shown in FIG. 7, or the water to be provided to the water jet nozzle 4860 installed at the opening 460 of the front panel 400, or the water to be provided to the drying duct 791 of the drying unit 790 as shown in FIG. 15.

To this end, the valve body 4880 includes a plurality of fluid paths 4881, 4883, 4885, 4887, 4888 and 4889 integrally formed for controlling water supply or water flow, and a plurality of valve housings 4882, 4884 and 4886 through-connected to the fluid paths 4881, 4883, 4885, 4887, 4888 and 4889.

For example, the valve body 4880 of the water supply valve assembly 480 includes a first fluid path 4881 connected to a first water outlet unit 4871 of the first water outlet unit 4880, for a flow of water to be supplied to the detergent input space 504 of the detergent container 500, as shown in FIGS. 8 to 10.

Further, the valve body 4880 includes a first valve housing 4882 connected to the first fluid path 4881 for the flow of water and installed with a first control valve 4811.

The fluid path of the valve body 4880 includes a second fluid path 4883 connected to the second water outlet unit 4872 at one side of the valve body 4880 for the flow of water to be supplied to the conditioner input space 506 of the detergent container 500.

Further, the valve body 4880 includes a second valve housing 4884 connected to a second fluid path 4883 for the flow of water and mounted with a second control valve 4812.

Further, the valve body 4880 includes a third fluid path 4885 connected to a third water outlet unit 4873 on the other side of the valve body 4880 for the flow of water.

Further, the valve body 4880 includes a third valve housing 4886 connected to a third fluid path 4885 for the flow of water and mounted with the third control valve 4813.

Further, the valve body 4880 includes a fourth fluid path 4887 connected between the first valve housing 4882 and the second valve housing 4884 along the extension direction of the first fluid path 4881.

Further, the valve body 4880 includes a fifth fluid path 4888 connected between the second valve housing 4884 and the third valve housing 4886 along the extension direction of the second fluid path 4883.

Further, the valve body 4880 includes a sixth fluid path 4889 connected between the second valve housing 4884 and the water inlet portion 4874 of the valve body 4880 along the same direction as the extending direction of the first fluid path 4881.

The side portions of the respective valve housings 4882, 4884 and 4886 may be formed with flow path passage holes (not shown) for interconnecting the corresponding valve housings 4882, 4884 and 4886 and fluid paths 4881, 4883, 4885, 4887, 4888 and 4889.

In addition, the valve housings 4882, 4884 and 4886 are arranged in a vertical or horizontal direction with respect to the front surface of the valve body 4880. For example, in order to arrange the valve housing 4882, 4884 and 4886, the valve body 4880 extends in a horizontal direction with a portion of valve body 4880 with respect to the front surface of valve body 4880, and the other portion of the valve body 4880 may extend in a vertical direction from an end of a part of the valve body 4880.

Referring to FIG. 11, the control valve 4810 includes a valve unit 4814 inserted into the opening region of any one of the valve housings 4882, 4884, and 4886 each corresponding to the first control valve 4811, the second control valve 4812, and the third control valve 4813.

Further, the control valve 4810 has a coil unit (not shown) to operate a valve unit 4814 each corresponding to each of the first control valve 4811, the second control valve 4812 and the third control valve 4813 (for example, valve opening or valve closing), and a terminal unit 4815 for applying a power or a signal to the coil unit.

The terminal unit 4815 is connected to the control unit 810 of FIG. 4 through a connector and an electric wire.

In addition, the control valve 4810 includes a plurality of brackets 4830 and 4840 coupled to walls 4870 and 4876 of the valve housing 4882, 4884 and 4886 corresponding to the outer periphery of the opening area so as to close the opening areas of the valve housings 4882, 4884 and 4876.

The valve body 4880 includes a bolt coupling unit 4875 formed on the wall 4870 and 4876 of any one of the first valve housing 4882, the second valve housing 4884 and the third valve housing 4886 so as to be coupled to the bolts of the brackets 4830 and 4840.

Referring concurrently to FIG. 9 or FIG. 11, the valve body 4880 includes a connecting rib 4877 formed between a wall 4870 of any one of the first valve housing 4882, the second valve housing 4884 and the third valve housing 4886 and a wall 4876 of the other one.

Thus, the valve body 4880 may be a rigid structure that minimizes structural deformation by the walls 4870 and 4876 and the connecting rib 4877.

The control valve 4810 is mounted to the brackets 4830 and 4840 in a single-mount or double-mount manner. That is, the brackets 4830 and 4840 include a bracket 4830 of a single mounting type in which the control valve 4810 is mounted in a single number, and the bracket 4840 of a double mounting type in which a control valve 4810 is mounted in a plurality of members (for example, two).

For example, the first control valve 4811 is mounted on the bracket 4830 of the single mounting type.

In addition, the second control valve 4812 and the third control valve 4813 are mounted on the bracket 4840 of the double mounting type.

For ease of description, the discussion will be made of the first control valve 4811 and the brackets 4830 and 4840 with respect to the bracket 4830 of the single mounting type.

For example, the bracket 4830 shown in FIG. 12 has an extension plate 4831 having an extension length corresponding to the height of the coil unit of the first control valve 4811 shown in FIG. 11.

Further, the bracket 4830 has a bracket plate 4832 bent at one end of the extension plate 4831 to be perpendicular to the extension plate 4831, and having a plurality of holes coinciding with a bolt hole of the bolt coupling unit 4875 and a center groove coinciding with the valve shaft of the first control valve 4811.

The bracket 4830 also includes a circular support plate 4833 bent at the other end of the extension plate 4831 to be parallel to the bracket plate 4832 and having a relatively small area as compared with the bracket plate 4832.

In this case, the support plate 4833 includes a plurality of seating grooves 4834 formed at an edge of the support plate 4883 and spaced apart along the edge to seat an elastic protrusion 4816 of the terminal unit 4815 provided in the first control valve 4811.

As shown in FIG. 13, the user may rotate the first control valve 4811 and the terminal unit 4815 from the bracket 4830 (as denoted by “R”). According to this rotation R, the elastic protrusion 4816 of the terminal unit 4815 may be seated in the seating groove 4834 at another position in the existing position. That is, since the direction of the contact metal end of the terminal unit 4815 may be changed, in order to interconnect the connector 811 at the end of the wire from the above-mentioned control unit 810 and the metal contact of the terminal unit 4815 as mentioned above, the approach direction of the connector 811 may be changed in compliance with the user's request (e. g. rotation). As a result, the production or maintenance performance of the washing machine may be increased.

Hereinafter, a method of operating the water supply valve assembly 480 will be described.

Referring to FIG. 14, the control unit 810 of FIG. 4 may allow the water introduced through the pipe coupler 4890 (as denoted by W/I (Water In)) to flow out toward each destination (as denoted by W/O (Water Out)) by selectively opening or closing a valve unit or at least one valve unit of the first control valve 4811, the second control valve 4812 and the third control valve 4813.

The control unit 810 controls the operations of the first control valve 4811, the second control valve 4812 and the third control valve 4813 to selectively perform a water supply operation each corresponding to a predetermined water supply process, a water directing process, a washing process, a rinsing process and a drying process.

In response to the operations of the first control valve 4811, the second control valve 4812 and the third control valve 4813, the water (W/I) may flow out (W/O) toward the pipes 21, 22 and 23 of the corresponding water outlet unit 4871, 4872 and 473.

FIG. 15 is a perspective view for explaining the inside of a washing machine having a drying unit according to an exemplary application of the present disclosure.

Referring to FIG. 15, an exemplary application of the present disclosure may change a water supply destination while using the water supply valve assembly 480.

For example, the water supply valve assembly 480 includes a branch pipe 30 for receiving the water exiting from the valve body 4880, and dividing and discharging the flow of water into a plurality of portions.

The branch pipe 30 is opened in three directions interconnected with one another and include an inlet 31, a first outlet 32 and a second outlet 33 formed at a lower portion or an upper portion of the branch pipe 30, wherein the inlet 31 receives water from the water supply valve assembly 480. Further, the first outlet 32 is formed in the branch pipe 30 with respect to one side of the opposite side of the inlet 31, and the second outlet 33 is formed in the branch pipe 30 with respect to the other side of the opposite side of the inlet 31.

According to the exemplary application of the present disclosure, the various pipes 21, 22 and 23 described in this embodiment, or the various connection pipes 41, 42, 43, 44 and 45 to be described below may have different colors so as to distinguish the paths of water.

Moreover, the pipes 21, 22 and 23 and the connection pipes 41, 42, 43, 44 and 45 include a name tag provided on the outside thereof, thereby improving accuracy of component assembly.

According to the application example of the present disclosure, the water supply valve assembly 480 includes a first connection pipe 41 for interconnecting the first water outlet unit 4871 of the valve body 4880 and the inlet 31 of the branch pipe 30.

Further, the water supply valve assembly 480 includes a second connection pipe 42 for interconnecting the first outlet 32 of the branch pipe 30 and the first fitting 441 of the detergent container receiving unit 420.

Further, the water supply valve assembly 480 includes a third connection pipe 43 for interconnecting the second outlet 33 of the branch pipe 30 and the water jet nozzle 4860 of the front panel 400.

The water delivered through the first connection pipe 41 to the water supply valve assembly 480 may be branched at the branch pipe 30 so that simultaneous water supply may be performed at the first fitting 441 and the water jet nozzle 4860.

In addition, the water supply valve assembly 480 may include a fourth connection 420 for interconnecting the second water outlet unit 4872 of the valve body 4880 and the second fitting 442 of the detergent container receiving unit 420, Consequently, an individual water supply may be made for the conditioner input space of the detergent container 500 through the second fitting 442.

Further, the water supply valve assembly 480 includes a fifth connection pipe 45 for interconnecting the third water outlet unit 4873 of the valve body 4880 and the water supply nozzle 792 of the drying duct 791 of the drying unit 790.

Accordingly, the individual water supply to the internal space of the drying duct 791 may be performed through the water supply nozzle 792.

The water flowing into the interior space of the drying duct 791 meets the internal flow air of the drying duct 791 of the drying unit 790. At that time, the inside air of the drying duct 791 and the inflow water are mutually heat exchanged.

The humidity of the inside air of the drying duct (791) becomes condensed water through heat exchange. Thereafter, the condensed water moves along the surface of the drying duct 791, and then is discharged to the outside through the drain portion of the drying duct 791. On the other hand, the internal dry air of the drying duct 791 with moisture removed may be supplied to the inside of the drum 600, and thus the laundry inside the drum 600 may be efficiently dried.

The wall-mounted washing machine and the water supply valve assembly thereof according to the embodiments of the present disclosure have an advantage in that the connection between the pipe (which is a supply flow path) and a fitting may be performed very easily and precisely.

Further, there is an advantage that a space between a cabinet corresponding to an external article of the washing machine and an internal article of the washing machine may be efficiently used.

Further, there is an advantage that functions of the washing machine (for example, a drying function, a function of spraying water directly to laundry, etc.) may be easily added or extended.

In addition, there is an advantage that due to the addition of functionality of the washing machine, the required installations of pipes and fittings may be performed very easily.

The above description is merely illustrative of the technical idea of the present disclosure and various changes and modifications may be made without departing from the essential characteristics of the present disclosure. Therefore, the embodiments described in the present disclosure are not intended to limit the scope of the present disclosure, but are intended to illustrate and not limit the scope of the present disclosure. The scope of protection of the present disclosure should be construed according to the following claims, and all technical ideas which are equivalent or equivalent thereto should be interpreted as being included in the scope of the present disclosure.

What is claimed is:

1. A wall mounted washing machine, comprising:
a rear panel operable to be mounted on a vertical surface;
a tub supported on the rear panel, the tub operable to contain wash water;
a front panel having an opening formed therein and disposed in the tub;
a drum installed in the tub and operable to rotate;
a cover installed on the front panel to protect a front surface of the front panel;
a door rotatably coupled to the cover to open and close a laundry inlet of the cover;
a cabinet coupled between the rear panel and the cover; and
a water supply valve assembly provided in an inner lower space of the cabinet and installed on the front panel.

2. The wall mounted washing machine of claim 1, wherein the front panel comprises an extension integrally formed on a lower side of the front panel and operable to install the water supply valve assembly.

3. The wall mounted washing machine of claim 2, wherein the extension comprises:
a base plate extending from a side surface of the front panel;
a base wall extending along an outer periphery of the base plate;
a plate reinforcing rib connected to the base wall and protruding from the base plate; and
a plurality of supports protruding from the extension with respect to the base plate, the base wall and the plate reinforcement rib, and
wherein each of the plurality of supports has a bolt hole formed at its end.

4. The wall mounted washing machine of claim 3, wherein each of the plurality of supports is spaced apart from the base plate or the plate reinforcement rib so that the water supply valve assembly may be disposed along an oblique direction from the extension with respect to the front surface of the front panel.

5. The wall mounted washing machine of claim 4, wherein the water supply valve assembly comprises supporting legs respectively fastened to the bolt holes of the plurality of supports.

6. The wall mounted washing machine of claim 5, wherein the bolt holes of the supports are formed at the end of the plurality of supports toward the water supply valve assembly.

7. The wall mounted washing machine of claim 4, wherein the plurality of supports has a protruding height that allows the water supply valve assembly to be spaced from the base plate or the plate reinforcing rib.

8. The wall mounted washing machine of claim 3, wherein the plurality of supports comprises:
a support base integrally formed with the base plate or the plate reinforcing rib; and
a support extension having a relatively small diameter as compared with the support base and thus a step difference and projecting from the support base toward the water supply valve assembly.

9. A wall mounted washing machine, comprising:
a rear panel operable to be mounted on a wall;
a tub supported on the rear panel and operable for storing wash water therein;
a control unit disposed outside the tub;
a front panel having an opening formed therein and installed in the tub;
a drum rotatably installed in the tub;
a cover installed on the front panel to protect a front surface of the front panel;
a door rotatably coupled to the cover to selectively open and close a laundry inlet of the cover;
a cabinet coupled between the rear panel and the cover;
a drying unit installed outside the tub and operable to supply into the drum; and
a water supply valve assembly provided in an inner lower space of the cabinet and installed in the front panel for selectively supplying water to at least one of the tub, the drum and the drying unit.

10. The wall mounted washing machine of claim 9, wherein the front panel comprises:
an extension integrally formed on the lower side of the front panel in order to install the water supply valve assembly;
a plurality of supports protruding from the extension and formed with a bolt hole at the end thereof; and
a detergent container receiving unit formed on the front panel to receive a detergent container.

11. The wall mounted washing machine of claim 10, wherein the water supply valve assembly is supported on the plurality of supports and is spaced apart from the extension.

12. The wall mounted washing machine of claim 10, wherein the water supply valve assembly comprises:
a valve body formed with a plurality of fluid paths for water flow in order to provide water supplied to the water supply valve assembly to a detergent input space of the detergent container, and to provide water to a conditioner input space divided from the detergent input space, and to provide water to a water jet nozzle installed into an opening of the front panel, and to provide the water to a drying duct of the drying unit; and
a plurality of control valves installed in the fluid paths for selectively supplying and blocking the water to/from the fluid paths, and
wherein the valve body is coupled to the plurality of supports by a bolt.

13. The wall mounted washing machine of claim 12, wherein the control valve comprises a solenoid valve or an electromagnetic valve electrically coupled to the control unit.

14. A water supply valve assembly for use in a wall mounted washing machine,
the wall mounted washing machine comprising:
a rear panel operable to be mounted on a wall;
a tub supported on the rear panel and operable to store wash water;
a front panel having an opening formed therein and installed in the tub;
a drum rotatably installed in the tub;
a cover installed on the front panel to protect a front surface of the front panel;
a door rotatably coupled to the cover in order to selectively open and close a laundry inlet of the cover;
a cabinet coupled between the rear panel and the cover;
a detergent container receiving unit formed on the front panel to receive a detergent container; a drying unit installed outside the tub and for supplying air into the drum;
a valve body installed on the front panel with respect to an inner lower space of the cabinet;
an inlet pipe through-connected to a water inlet side of the valve body; and
a plurality of pipes wherein each is through-connected to the water outlet side of the valve body.

15. The water supply valve assembly of claim 14, wherein the water supply valve assembly comprises:
a pipe coupler connecting the water inlet side of the valve body and the water inlet pipe to each other to flow the water.

16. The water supply valve assembly of claim 15, wherein the piping coupler comprises a coupler fixing unit protruding from a surface of the pipe coupler and fixed to an extension of a lower side of the front panel by a bolt, wherein a hole for fastening the bolt is formed in the coupler fixing unit.

17. The water supply valve assembly of claim 14, wherein the water supply valve assembly comprises:
a first pipe interconnecting a first water outlet unit of the valve body and a first fitting of the detergent container receiving unit;
a second pipe interconnecting a second water outlet unit of the valve body and a second fitting of the detergent container receiving unit; and
a third pipe interconnecting a third water outlet unit of the valve body and a water jet nozzle of the front panel.

18. The water supply valve assembly of claim 14, wherein the water supply valve assembly comprises;
a branch pipe for receiving water exiting from the valve body and dividing the flow of the water into a plurality of portions to discharge the water.

19. The water supply valve assembly of claim 18, wherein the branch pipe comprises:
an inlet formed in the branch pipe to receive water from the water supply valve assembly;
a first outlet formed in the branch pipe with respect to one side of the opposite side of the inlet port; and
a second outlet formed in the branch pipe with respect to the other side of the opposite side of the inlet.

20. The water supply valve assembly of claim 19, wherein the water supply valve assembly comprises:
a first connection pipe interconnecting a first water outlet of the valve body and an inlet of the branch pipe;
a second connection pipe interconnecting a first outlet of the branch pipe and a first fitting of the detergent container receiving unit;
a third connection pipe interconnecting a second outlet of the branch pipe and a water jet nozzle of the front panel;
a fourth connection pipe interconnecting a second water outlet of the valve body and a second fitting of the detergent container receiving unit; and
a fifth connection pipe interconnecting a third water outlet of the valve body and a water supply nozzle of a drying duct of the drying unit.
